(19) United States
(12) Patent Application Publication
(10) Pub. No.: US 2019/0001606 A1
(43) Pub. Date: Jan. 3, 2019

(54) RELEASABLE PAIR OF DUAL NESTED CORRUGATED SHEETS AND METHOD OF FORMING SAME

(71) Applicant: WestRock Shared Services, LLC, Atlanta, GA (US)

(72) Inventor: Chris B. POLSTER, North Richland Hills, TX (US)

(21) Appl. No.: 16/018,569

(22) Filed: Jun. 26, 2018

Related U.S. Application Data
(60) Provisional application No. 62/527,133, filed on Jun. 30, 2017.

(51) Int. Cl. B31F 1/28; B31D 1/00; B31F 5/00

(52) U.S. Cl. CPC B31F 1/2813; B32B 5/14; B31F 5/008; B31D 1/0075

(57) ABSTRACT

A releasable pair of dual nested corrugated sheets comprises a top liner, a bottom liner and a combined web. The combined web comprises a first material coupled to a second material without an adhesive. The combined web further comprises a plurality of corrugations. The top liner is partially coupled to the combined web using an adhesive. The bottom liner is partially coupled to the combined web using an adhesive. The pair of dual nested corrugated sheets is releasable such that the top liner and the first material is separate from the bottom liner and the second material.

### REFERENCE TO RELATED APPLICATION

This application claims the benefit of priority under 35 U.S.C. § 119(e) of U.S. provisional application Ser. No. 62/527,133 filed on Jun. 30, 2017, which is hereby incorporated by reference in its entirety.

### BACKGROUND

The field of the disclosure relates generally to sheets of material and a method of forming sheets of material, and more particularly, to a releasable pair of dual nested corrugated sheets and a method of forming a releasable pair of dual nested corrugated sheets.

A blank, formed from a sheet of material such as paperboard and/or corrugated paperboard material, can be used to separate and protect goods during transportation. Corrugated paperboard material can be composed of a liner coupled to a corrugated medium and is generally known as a single face web. The single face web is less rigid and more delicate due to one surface of the corrugated medium not being coupled to a second liner. During production of a single face web, the machine used to produce the single face web must produce a narrower width of the single face web to protect the structure of the corrugated medium. In some cases, the machine is able to perform various operations on such a single face web, such as scoring, slitting, and/or cutting. However, due to the more delicate nature of the single face web, these machines must perform these operations at slower operating speeds, such as at speeds at or below 140 ft/min, to protect the structure of the corrugated medium of the single face web. Moreover, a blank formed from the single face web typically requires a separate container to protect the structure of the corrugated medium during transportation. The need for a separate container during transportation of the single face web provides an additional cost.

As such, it is desirable to provide a sheet of material can be manufactured larger (e.g., wider), at higher rates of speed, and in such a way where a separate, additional shipping container is not required to ship the single face web to the customers.

### BRIEF DESCRIPTION

In one aspect, a method for forming a releasable pair of dual nested corrugated sheets from a first material, a second material, a top liner, and a bottom liner is provided. The method includes corrugating the first material and the second material together to form a combined web. The method also includes coupling the top liner to the combined web. The method also includes coupling the bottom liner to the combined web to form a combined board. The method further includes cutting the combined board to a length to form a releasable pair of dual nested corrugated sheets.

In another aspect, a system for forming a releasable pair of dual nested corrugated sheets is provided. The system includes a machine configured to corrugate the first material and the second material together to form a combined web. The machine is also configured to couple the top liner to the combined web. The machine is also configured to couple the bottom liner to the combined web to form a combined board. The machine is further configured to cut the combined board to a length to form a releasable pair of dual nested corrugated sheets.

In another aspect, a releasable pair of dual nested corrugated sheets is provided. The pair of dual nested corrugated sheets includes a combined web having a first medium and a second medium. The pair of dual nested corrugated sheets also includes a top liner coupled to the combined web. The pair of dual nested corrugated sheets further includes a bottom liner coupled to the combined web.

### BRIEF DESCRIPTION OF THE DRAWINGS

FIG. 1 is a schematic side view of a first portion of a machine for forming a releasable pair of dual nested corrugated sheets.

FIG. 2 is a schematic side view of a second portion of the machine for forming the releasable pair of dual nested corrugated sheets.

FIG. 3 is a schematic side view of a third portion of the machine for forming the releasable pair of dual nested corrugated sheets.

FIG. 4 is a side view of a releasable pair of dual nested corrugated sheets.

FIG. 5 is a perspective view of the releasable pair of dual nested corrugated sheets shown in FIG. 4.

FIG. 6 is a side view of the releasable pair of dual nested corrugated sheets shown in FIG. 4 in a partially unnested state.

FIG. 7 is a side view of the releasable pair of dual nested corrugated sheets shown in FIG. 4 in a fully unnested state.

FIG. 8 is a side view of a segment of single face combined web formed as an intermediate material in the first section of the machine for forming the releasable pair of dual nested corrugated sheets shown in FIG. 1.

FIG. 9 is a perspective view of a stack of exemplary blanks formed from the releasable pair of dual nested corrugated sheets shown in FIG. 4.

FIG. 10 is a perspective view of the exemplary blank shown in FIG. 9 in a partially unnested state.

### DETAILED DESCRIPTION

The embodiments described herein provide a releasable pair of dual nested corrugated sheets formed from a first corrugated medium and a second corrugated medium, and a pair of liners attached to one of the mediums, and a method for forming the same. As described herein, the dual nested corrugated sheets are releasably coupled together in a pair and remain coupled by friction and the nesting of the two corrugated mediums. The first and second corrugated mediums of the dual nested corrugated sheets are the portion of the sheets that are coupled (e.g., nested) together. The pair of liners forms a top surface and a bottom surface of the pair of dual nested corrugated sheets. The pair of dual nested corrugated sheets is attached but releasable by pulling the sheets apart (e.g., applying a separate force sufficient to overcome the nesting and friction force holding the two single web sheets together).

The invention described herein can be manufactured larger (e.g., wider) and at higher rates of speed. During production, the pair of dual nested corrugated sheets can be produced on a larger scale than single face web because of the presence of the pair of liners which protect the delicate structure of the combined web. The pair of liners increases the output by allowing the pair of dual nested corrugated sheets to be manufactured larger and at higher rates of speed, such as at speeds between 500 ft/min to 1,500 ft/min. Moreover, the dual nature of the pair of dual nested corrugated sheets doubles this increased output of single face web sheets. For each pair of dual nested corrugated sheets produced, two sheets of single face web are provided to the customer. Upon shipment of a pair of dual nested corrugated sheets to a customer, the customer is able to decouple the pair of dual nested corrugated sheets, resulting in two sheets of single face web.

The invention described herein also can be produced in such a way where a separate, additional shipping container is not required to ship the single face web to the customers. The presence of the pair of liners in the pair of dual nested corrugated sheets protects the delicate structure of the combined web. The protection offered by the pair of liners allows the pair of dual nested corrugated sheets to be strapped together for shipment. Conversely, single face web must be packaged in a separate shipping container to protect the corrugated web. The present invention eliminates the requirement for an additional, separate shipping container when shipping single face web which provides cost savings.

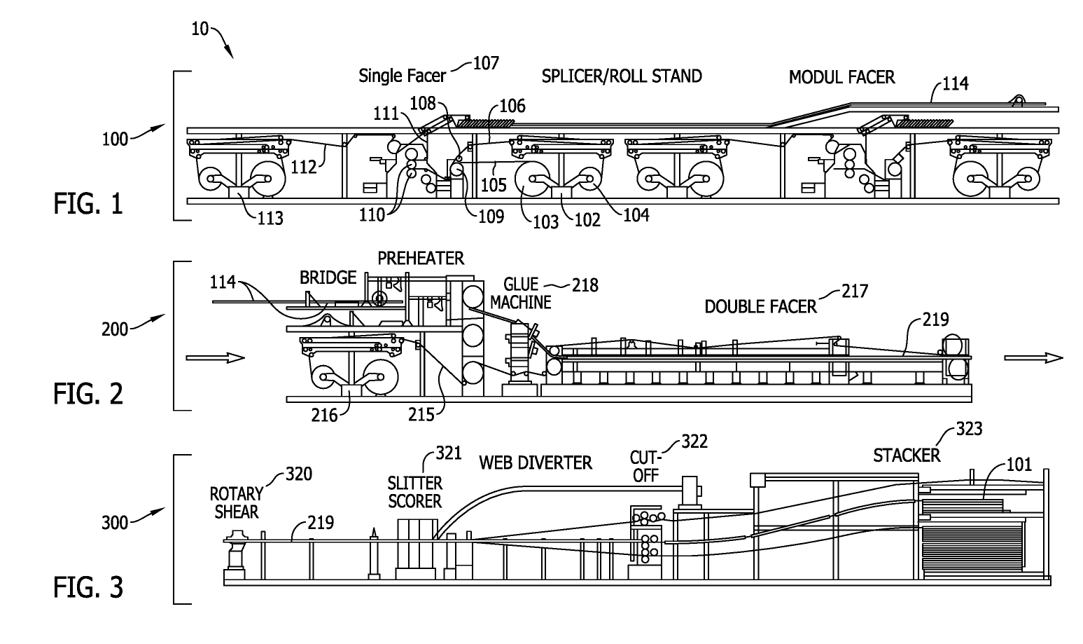

FIGS. 1-3 illustrate a schematic side view of sections of a machine 10 for forming a releasable pair of dual nested corrugated sheets 101. More specifically, FIGS. 1-3 illustrate a schematic side view of a first section 100, a second section 200, and a third section 300, respectively. As shown in FIG. 1, first section 100 of machine 10 includes a first roller assembly 102 which includes a first roll 103 and a second roll 104. In the example embodiment, first roll 103 of a first medium 105 is stored on first roller assembly 102 and second roll 104 of a second medium 106 is stored on first roller assembly 102. First roller assembly 102 is configured to feed first roll 103 of first medium 105 to a single facer mechanism 107. First roller assembly 102 is also configured to feed second roll 104 of second medium 106 to single facer mechanism 107. In some embodiments, single facer mechanism 107 includes a spray bar 108 configured to spray a fluid, such as water, on first and second mediums 105, 106 to facilitate releasably coupling the medium sheets together. In some embodiments, single facer mechanism 107 includes roll 109. In these embodiments, first and second mediums 105, 106 are fed to roll 109. In certain embodiments, second medium 106 is fed to roll 109 in a position substantially above first medium 105. In alternative embodiments, second medium 106 is fed to roll 109 in any other suitable position that enables first and second mediums 105, 106 to be fed to roll 109. In single facer mechanism 107, the first and second mediums 105, 106 are conveyed along a single path. First and second mediums 105, 106 are compressed by corrugating rolls 110 to form a combined web 111 having a plurality of corrugations or flutes.

First section 100 also includes a supply of top liner 112 stored on a second roller assembly 113. Second roller assembly 113 is configured to feed top liner 112 to single facer mechanism 107. An adhesive material is applied to a bottom surface of top liner 112 and/or to a top surface of combined web 111 in the single facer mechanism 107. At single facer mechanism 107, top liner 112 is coupled to the combined web 111 forming a single face combined web 114. Single face combined web 114 exits single facer mechanism 107 and is conveyed to second section 200.

As shown in FIG. 2, second section 200 includes a roll of a bottom liner 215 stored on a third roller assembly 216. Third roller assembly 216 is configured to feed bottom liner 215 to a double facer mechanism 217. Once single face combined web 114 enters second section 200, single face combined web 114 is conveyed to double facer mechanism 217. An adhesive material is applied to a bottom surface of single face combined web 114 and/or to a top surface of bottom liner 215 by a glue machine 218. At double facer mechanism 217, single face combined web 114 is coupled to bottom liner 215 to form a combined board 219. Combined board 219 exits double facer mechanism 217 and is conveyed to third section 300.

As shown in FIG. 3, third section 300 may include a plurality of components, such as a rotary shear 320, a slitter scorer 321, a cut-off component 322, and a stacker 323. Once combined board 219 enters third section 300, rotary shear 320 and slitter scorer 321 provide finishing operations to combined board 219. Combined board 219 is conveyed to cut-off component 322. Cut-off component 322 is configured to perform a cutting operation on combined board 219 to form a releasable pair of dual nested corrugated sheets 305. Pair of dual nested corrugated sheets 101 is conveyed to stacker 323. Stacker 323 is configured to stack one or more pairs of dual nested corrugated sheets 101. The stack of pairs of dual nested corrugated sheets 101 may be strapped and sent to a customer without the need to further package them in a separate shipping container.

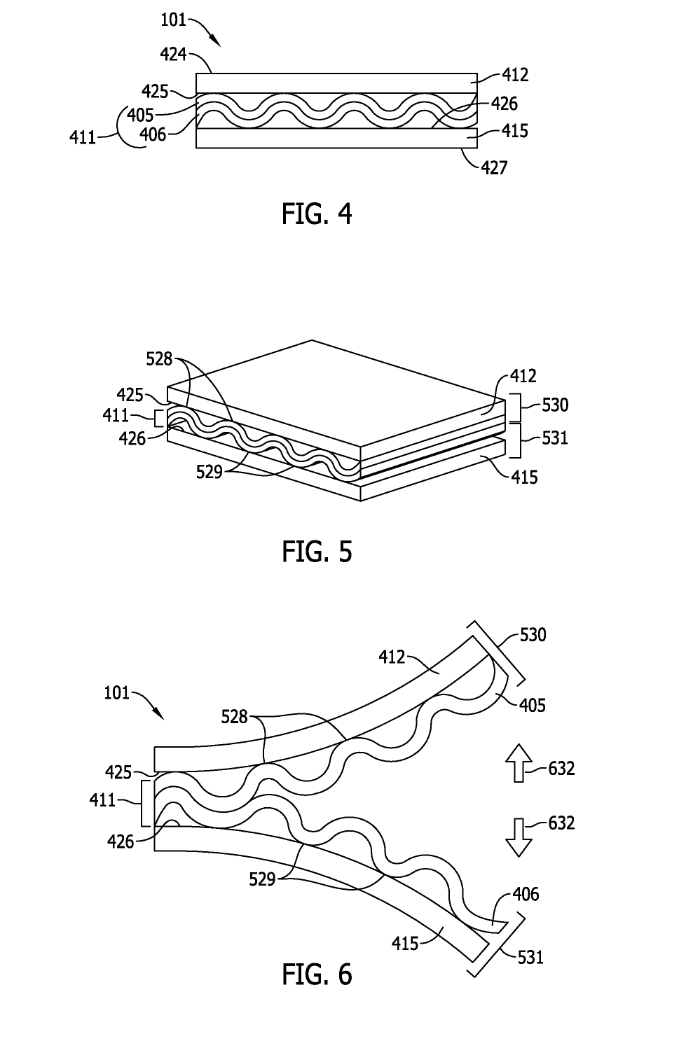

FIG. 4 illustrates a side view of a pair of dual nested corrugated sheets 101. Pair of dual nested corrugated sheets 101 includes a top liner 412, a bottom liner 415, and a combined web 411. Combined web 411 includes a first medium 405 from first roll 103 and a second medium 406 from second roll 104. First medium 405 and second medium 406 are coupled together without an adhesive material. Rather, first medium 405 and second medium 406 are releasably coupled by friction and/or nesting. Top liner 412 includes a top surface 424 and a bottom surface 425. Bottom liner 415 includes a top surface 426 and a bottom surface 427.

FIG. 5 illustrates a perspective side view of a pair of dual nested corrugated sheets 101. As shown in FIG. 5, combined web 411 includes a plurality of upper corrugations or flutes 528 and a plurality of lower corrugations or flutes 529. Upper flutes 528 are coupled to bottom surface 425 of top liner 412, such as using an adhesive, to form upper corrugated sheet 530. Lower flutes 529 are coupled to top surface 426 of bottom liner 415, such as using an adhesive, to form lower corrugated sheet 531.

FIG. 6 illustrates a side view of a releasable pair of dual nested corrugated sheets 101 in a partially unnested state. Application of a pair of opposing forces 632 to pair of dual nested corrugated sheets 101 partially decouples upper corrugated sheet 530 from lower corrugated sheet 531. The forces 632 are sufficiently strong enough to overcome the friction and/or nesting forces holding the two mediums together during production. First medium 405 and second medium 406 are coupled in combined web 411 without the presence of an adhesive material which allows the application of forces 632 to decouple upper corrugated sheet 530 from lower corrugated sheet 531. Upper flutes 528 of combined web 411 may be coupled to bottom surface 425 of top liner 412 using an adhesive. Similarly, lower flutes 529 of combined web 411 may be coupled to top surface 426 of bottom liner 415 using an adhesive. The presence of an adhesive prevents the application of forces 632 from decoupling first medium 405 from top liner 412 and second medium 406 from bottom liner 415. A customer may apply forces 632 to pair of dual nested corrugated sheets 101 to separate upper corrugated sheet 530 from lower corrugated sheet 531. Upper corrugated sheet 530 and lower corrugated sheet 531 may each be a sheet of single face web.

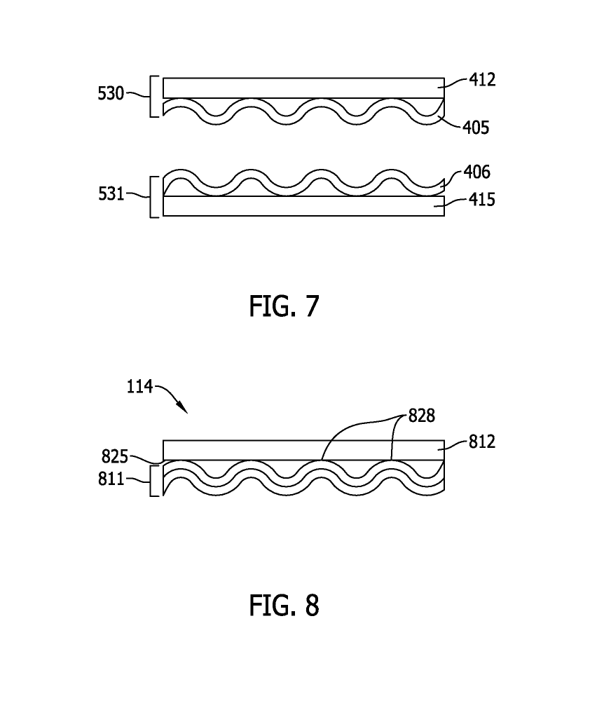

FIG. 7 illustrates a side view of a releasable pair of dual nested corrugated sheets 101 shown in FIG. 4 in a fully unnested state. When pair of dual nested corrugated sheets 101 is in a fully unnested state, top liner 412 and first medium 405 form upper corrugated sheet 530 and bottom liner 415 and second medium 406 form lower corrugated sheet 531.

FIG. 8 illustrates a side view of a segment of single face combined web 114 formed in the first section 100 shown in FIG. 1. Upper flutes 828 of a combined web 811 are coupled, such as using an adhesive, to a bottom surface 825 of a top liner 812.

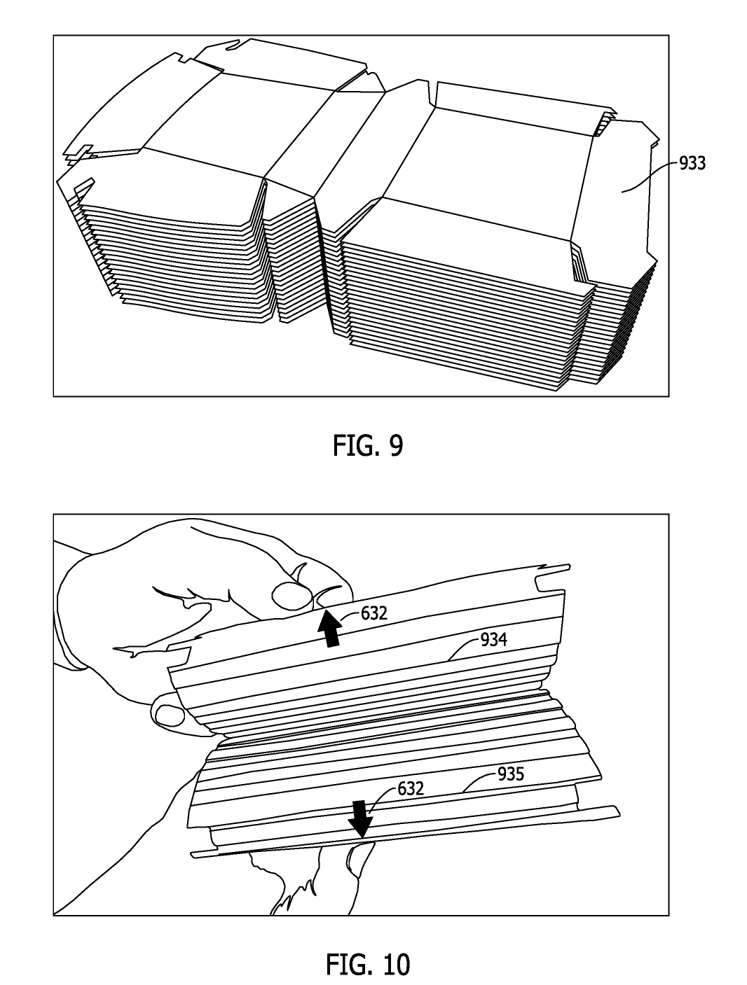

FIG. 9 illustrates a perspective side view of a stack of exemplary pairs of dual nested corrugated blanks 933 formed from pairs of dual nested corrugated sheets 101. Exemplary pairs of blanks 933 are in a clamshell configuration. However, pairs of blanks 933 of various configurations may be formed from pairs of dual nested corrugated sheets 101. FIG. 10 illustrates an application of forces 632 on one of the exemplary pairs of dual nested corrugated blanks 933 shown in FIG. 9 to release a first corrugated blank 934 from a second corrugated blank 935. First corrugated blank 934 and second corrugated blank 935 may each be a blank of single face web.

The benefits of the invention include an ability to be manufactured larger (e.g., wider), at higher rates of speed, and in such a way where a separate, additional shipping container is not required to ship the single face web to the customers. Combined board 219 moving through third section 300 can be wider than typical single face web because combined board 219 contains top liner 112 applied in first section 100 and bottom liner 215 applied in second section 200. The presence of top liner 112 and bottom liner 215 protects the corrugated structure of combined web 111 in combined board 219. This protection allows the finishing operations provided by rotary shear 320 and slitter scorer 321 to run at faster operating speeds, such as speeds of 500 ft/min to 1,500 ft/min, resulting in an increased output. Moreover, this increased output is doubled because a customer is able to apply forces 632 to pair of dual nested corrugated sheets 101 to separate upper corrugated sheet 530 from lower corrugated sheet 531.

Additionally, the invention provides a cost savings to the customer. The pairs of dual nested corrugated sheets 101 may be strapped and sent to a customer without the need to further package them in a separate shipping container.

The invention also allows faster production of blanks. A blank that includes a pair of dual nested corrugated sheets 101, such as one of pairs of blanks 933, is firm, provides stability, and protects the corrugated structure of combined web 111. Moreover, output of corrugated blanks 934, 935 is doubled because a customer is able to apply forces 632 to one of pairs of dual nested corrugated blanks 933 to separate a first corrugated blank 934 from a second corrugated blank 935. Conversely, a blank composed of single face web requires extra precautions to not damage the corrugated medium during production of the blank composed of single face web.

Exemplary embodiments of a releasable pair of dual nested corrugated sheets and a method of forming a releasable pair of dual nested corrugated sheets are described above in detail. The apparatus and methods are not limited to the specific embodiments described herein, but rather, components of apparatus and/or steps of the methods may be utilized independently and separately from other components and/or steps described herein.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to illustrate the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for forming a releasable pair of dual nested corrugated sheets from a first material, a second material, a top liner, and a bottom liner, said method comprising:
corrugating the first material and the second material together to form a combined web;
coupling the top liner to the combined web;
coupling the bottom liner to the combined web to form a combined board; and
cutting the combined board to a length to form the releasable pair of dual nested corrugated sheets.

2. The method in accordance with claim 1, further comprising:
applying a fluid to the first material and the second material;
applying a first adhesive to the top liner;
applying a second adhesive to the bottom liner;
slitting the combined board to a width;
scoring the combined board; and
stacking at least one of the releasable pair of dual nested corrugated sheets.

3. A system for forming a releasable pair of dual nested corrugated sheets, the system comprising:
a machine configured to:
corrugate the first material and the second material together to form a combined web;
couple the top liner to the combined web;
couple the bottom liner to the combined web to form a combined board; and
cut the combined board to a length to form a releasable pair of dual nested corrugated sheets.

4. The system in accordance with claim 3, wherein the machine is further configured to apply a fluid to the first material and the second material;
apply a first adhesive to the top liner;
apply a second adhesive to the bottom liner;
slit the combined board to a width;
score the combined board; and
stack at least one of the releasable pair of dual nested corrugated sheets.

5. A releasable pair of dual nested corrugated sheets comprising:
a combined web having a first medium and a second medium;
a top liner coupled to the combined web; and
a bottom liner coupled to the combined web.

6. A releasable pair of dual nested corrugated sheets in accordance with claim 5, wherein the releasable pair of dual nested corrugated sheets is releasable such that the top liner and the first medium are separable from the bottom liner and the second medium.
